(19) United States
(12) Patent Application Publication
(10) Pub. No.: US 2009/0224537 A1
(43) Pub. Date: Sep. 10, 2009

(54) BRAKE TUBE END FLARE

(75) Inventor: Stanislav Ivanovitch Pliassounov, Oakville (CA)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/045,151

(22) Filed: Mar. 10, 2008

(51) Int. Cl. F16L 15/00; F16L 9/00

(52) U.S. Cl. 285/331; 138/177

(57) ABSTRACT

A brake line for a brake system and a hydraulic tubing connector assembly are disclosed. The brake line includes a flare end having an inner wall that includes two or three distinct partially conical surfaces. A sealing area is defined between a run-out cone at the small frustum diameter of the inner wall and a chamfer is defined between the sealing area and the large frustum diameter of the inner wall of the flare.

### BACKGROUND OF THE INVENTION

1. Field of the Invention

The present invention relates to hydraulic tubing connector assemblies such as those used for a vehicle brake line, and in particular, a flared end of the brake line that is used in connector assemblies.

2. Background Art

Brake lines are used in hydraulic brake systems that are connected to different components of a brake system. Connector assemblies are used to connect the ends of brake lines to receptacles formed on various components of the brake system, such as the master cylinder, hydraulic unit and other brake hose fitting connections. Brake tube end fittings are made in accordance with SAE standard J533 or JASO Standard F 402-2001. Brake tubes are formed with single wall or double wall flares. Standard end flares are available as 37° or 45° single and double flares that are used with 37° flared tube fittings and 45° flared fittings.

Conventional brake tube lines are formed of mild steel or copper that offer substantial malleability. In recent years, brake tube lines are increasingly being manufactured as extruded aluminum tubes. Extruded aluminum tubes tend to be less malleable. A brake tube end with a double inverted flare construction that is made according to the above standards may be prone to leakage if not properly assembled to the connector assembly.

As shown in prior art FIGS. 7A-D, improper assembly of the brake tube to the connector may be the result of angular misalignment and/or lateral misalignment of the brake tube relative to the connector. To illustrate the misalignment in FIGS. 7A-D, the tube axis is indicated by the phantom line “TA” and the receptacle axis is indicated by the phantom line “RA.” Referring specifically to FIG. 7A, the flare's small frustum diameter may be larger than the seat's diameter and it is possible that the corner formed at the flare's small frustum diameter may initially contact the seat sidewall. The corner can dig in or gouge the seat on one side while leaving leakage path on the other side of the connector. The tube axis TA is angularly misaligned as illustrated.

Referring to FIG. 7B, if the angle of the flare on the tube end or seat are out of spec, the outer edge of the flare can initially contact the seat. The tube axis TA is again angularly misaligned. A sharp edge on the outer edge of the flare can cause an increase in the coefficient of friction between the flare and the seat that can result in a locked misalignment when the connector is tightened to secure the brake to the seat.

Referring to FIG. 7C, if the brake tube is initially laterally misaligned relative to the seat of the receptacle, the inner edge of the flare may contact the seat on one side leaving a leakage path at the opposite side. The tube axis TA is laterally offset relative to the receptacle axis RA as illustrated. Contact of the inner edge of the flare may also mark or gouge the seat leading to additional potential leak paths caused by the misalignment.

Referring to FIG. 7D, the brake tube may be both laterally and angularly misaligned in which case, the outer edge of the flare may engage the seat and a gap or opening may be created at the opposite diametrical location from the initial contact point. The tube axis TA is both angularly misaligned and laterally offset relative to the receptacle axis RA. The sharp edge on the outer edge can result in damage to the seat or an additional leakage path.

Any of the above conditions may result in the flare being locked in a misaligned state against the seat so that an effective seal is not established. Locked misalignment inhibits self-adjustment as mutual motion of the components becomes more restricted. While reasonable torque increases may accommodate some misalignment, sufficient deformation of the flare end may not be possible to establish the seal. Further increase in torque applied to the nut may deform the other elements of the connector assembly. In some conditions, the initial flare-to-seat contact may occur on a point instead of in a ring area of contact. Any local irregularity at the initial contact area may increase the effective coefficient of friction. As the friction increases, the flare may be progressively squeezed to a greater extent between the seat and the nut. In some instances, angular or lateral misalignment may result in one of the edges of the flare digging into the seat instead of sliding onto the seat.

The design intent for mating flares to the seat of a connector is to provide a continuous ring of contact between the flare and the seat. If the flare and seat are properly aligned, sized, and shaped, the contact area increases as the connector is secured by turning the threaded nut to drive a partially conical portion of the flare against the seat. Critical requirements for flare geometry include the length of the seat and smoothness of the surface to ensure an adequate seal. The flare's frustum small diameter should be less than the seat's frustum small diameter. The flare angle must always be greater than the seat's cone angle and some degree of flexibility of the flare is required to provide proper contact for the seat and compensate for any deviation in part shapes or imperfections.

The seat length or length of the sealing surface must be sufficiently generous to avoid misalignment or deformation. It is difficult to measure the actual length of the seat or sealing surface provided on the flare because the forming process for manufacturing the flare may result in the formation of a sharp edge or rounded end. Further, the inner diameter may be irregular, including splits or a nonuniform edge. Variations in small frustum diameter and the large frustum diameter of the flare make it almost impossible to accurately gage the length of the sealing surface.

In conventional manufacturing processes used to form the end flare, a cone shape is formed by a cone-shaped tool that is positioned in a die. During the forming stroke, the material flows and fills the cavity between the insert and the die. Variation in the relative position of the tube relative to the tooling may cause minor variations from one stroke to another. Batch-to-batch variation may occur due to different settings of the tooling, variation in the metallurgical content of the tubing material, variations in the mechanical properties of the tubing materials, and wear of the tooling. Material flow occurring as a result of the manufacturing process may not fill the entire available volume within the tool. Material flows from the large frustum diameter area towards the small frustum diameter area along the cone edge between the cone surface and the flare-end plane. Under optimal material and tooling conditions, all of the available volume in the forming tool is filled and an edge is likely to be formed between the cone surface and the end plane of the flare. If the material available during the forming process is less than optimal, the actual size of the flare's frustum diameter may be increased due to a failure of the material to flow completely into the inner frustum diameter. In this case, insufficient material may be available to fully form the cone sealing surface of the flare. This may lead to unpredictability as to the size of the flare's small frustum diameter.

Full formation and stability of the flare's small frustum diameter is best achieved at the maximum material condition, however, maximum material condition may lead to unwanted edge formation at the large frustum diameter. Both potential problem areas cannot be addressed simultaneously since variation reduction at the flare's small frustum area can be accomplished only at the expense of possible edge formation at the large frustum diameter.

The above problems and shortcomings of the prior art are addressed by Applicant's invention as summarized below.

### SUMMARY OF THE INVENTION

According to one aspect of the present invention, a brake tube or brake line is provided with an end flare that has a bi-cone or tri-cone flare on a double inverted flare. A bi-cone flare has a chamfer and a sealing cone. A tri-cone flare has a chamfer, a sealing cone and a run-out cone. The sealing cone is intended to provide sealing by mating with the cone sealing surface of a seat of a connector assembly. The sealing cone surface is oriented at an angle that is essentially the same as prior art inverted flare tube ends. The chamfer provides a second cone adjoining the sealing cone at the flare end side. The run-out cone adjoins the sealing cone at the small frustum diameter. The chamfer extends away from the sealing surface toward the flare-end plane.

The chamfer surface is preferably formed at an angle of between 55° and 85° with the sealing cone being formed at an angle of about 45°. Forming an edge at the border area between the chamfer and the sealing cone should be avoided and a radius may be formed at the intersection of the two cone surfaces.

The run-out cone is located at the sealing cone's small frustum diameter. The run-out cone is provided to control variation in the sealing cone's small frustum diameter which should be nominally smaller than the diameter of the seat's frustum. The run-out cone is intended to accommodate unwanted variation in the amount of material at the small frustum diameter of the sealing surface. The run-out cone surface is oriented at an angle of between 5° and 40° relative to the central axis of the tube. The run-out cone may be provided in an alternative bi-cone embodiment in which no chamfer surface is provided, as with the prior art flare end but the sealing surface and run-out cone are provided.

By providing a tri-cone flare, nonconformance to the inverted flare specification can be verified by a simple visual observation or with simple quality control gauges.

If, for example, the run-out cone is missing, it can be determined by visual inspection that the material flowing to form the inverted flare was below the intended acceptable minimum quantity of material. If the material flow stops at the sealing cone portion of the tool, the part is defective and the sealing cone's small frustum diameter may be greater than the small diameter of the seat's cone.

According to another aspect of the invention, a hydraulic tubing connector assembly is provided. The connector assembly comprises a receptacle having a tubular projection that defines a sealing seat. The sealing seat is tapered from an outer radius to an inner radius with the inner radius projecting to a greater extent than the outer radius. The receptacle has a threaded bore that is spaced outwardly from the tubular projection. A tube is secured to the receptacle that has an end, including an outer wall that is flared outwardly to form a frustum of a cone. The end has a reversely-turned portion that defines an inner wall that is formed with a sealing area in the shape of a frustum of a cone. The sealing area is oriented generally at the same angular orientation as the outer wall. The inner wall defines a chamfered surface at the large frustum diameter of the inner wall that has an increased angle of inclination relative to the central axis of the tube than the angle of inclination of the sealing area relative to the central axis of the tube. A tubular fastener having a threaded surface is screwed onto the threaded bore of the receptacle that forms part of the tubing connector assembly. An engagement surface of the tubular fastener is formed in the shape of a frustum of a cone on a distal end of the fastener. The engagement surface bears upon the outer wall of the tube driving the inner wall of the tube to seal against the seat of the receptacle.

According to another aspect of the present invention, a brake line for a brake system of the vehicle is provided that comprises a tube having first and second ends. The ends of the tube each have an outer wall that is flared outwardly in the shape of a frustum of a cone. Each end has a reversely-turned portion that defines an inner wall that is formed with a sealing area in the shape of a frustum of a cone. The inner wall is nested within the outer wall. The inner wall has a run-out surface that is formed as a frustum of a cone at a small frustum diameter of the inner wall that has a lower angle of inclination relative to an axis of the tube in comparison to an angle of inclination of the sealing area relative to the axis of the tube.

According to another aspect of the invention, a brake line is provided for a brake system of the vehicle that comprises a tube having first and second ends. The first and second ends each have an outer wall that is flared outwardly in the shape of frustum of a cone. The ends of the tube each have a reversely-turned portion that defines an inner wall that is formed with a sealing area in the shape of a frustum of a cone. The inner wall is nested within the outer wall and is relieved at a large frustum diameter of the wall relative to the sealing area. The inner wall is also relieved at a small frustum diameter of the inner wall relative to the sealing area. The length of the sealing area, as measured from the large frustum diameter to the small frustum diameter, may be specified as a critical dimension that is not permitted to be less than a predetermined value, i.e., 1.2 millimeters.

These and other aspects of the invention will be better understood in view of the attached drawings and the following detailed description of the illustrated embodiment.

### BRIEF DESCRIPTION OF THE DRAWINGS

FIG. 1 is a perspective view of a brake tube connector assembly with the tube and tubular fastener separated from the receptacle.

FIG. 2 is a cross-sectional view of a hydraulic tube connector assembly having a bi-cone inner flare surface.

FIG. 3 is a diagrammatic view showing a tube end flare having a bi-cone inner surface shown above a flare tube made according to current SAE and JASO standards.

FIG. 4 is a fragmentary diagrammatic view partially in cross-section showing a tool engaging brake tube end to form a bi-cone inner surface.

FIG. 5 is a fragmentary cross-sectional view showing a brake tube end flare having a tri-cone inner surface.

FIG. 6 is a diagrammatic view showing a tool about to engage a partially formed brake tube end flare to form a tri-cone surface on the inner surface thereof.

FIGS. 7A-7D show four different misalignment conditions that may exist with the prior art double inverted flares made according to current standards.

### DETAILED DESCRIPTION OF THE PREFERRED EMBODIMENT(S)

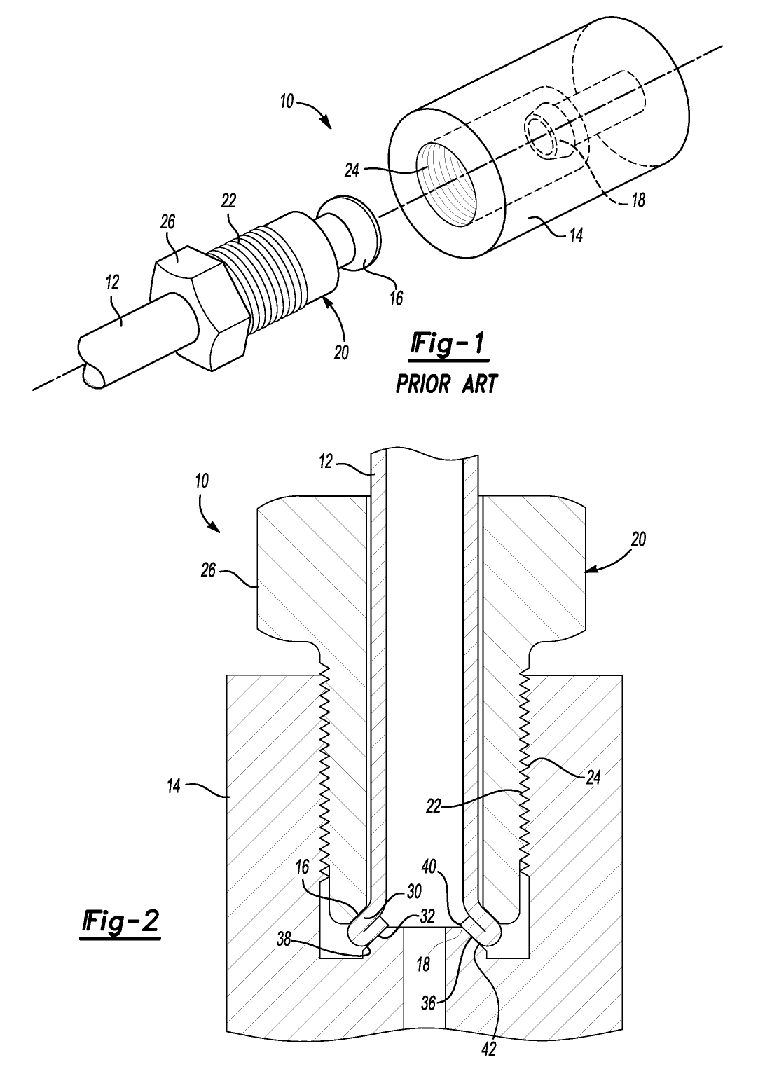

Referring to FIG. 1, a prior art hydraulic tubing connector assembly 10 is shown that comprises a brake tube 12 that is connected to a receptacle 14. The brake tube 12 includes flare end 16 that is assembled to a seat 18 within the receptacle 14. A tube connector 20 is assembled onto the brake tube 12 prior to forming the flare end 16 on the brake tube 12. The tube connector 20 has an externally threaded tubular portion 22 that is inserted into and connected to an internally threaded tubular portion 24. The tube connector 20 also includes a hex nut portion 26 that is engaged by a tool to secure the tube connector 20 to the receptacle 14. The tube connector 20 forces the flare end 16 against the seat 18 to form a seal that is intended to prevent leakage of brake fluid from the hydraulic tubing connector assembly 10. It should be understood that the brake tube includes a similar hydraulic tubing connector assembly 10 on the opposite end of the brake tube 12. The ends of the brake tube 12 are secured to components of the brake system.

Referring to FIG. 2, a connector assembly 10 is shown. The brake tube 12 is shown in engagement with the flare end 16 of the brake tube engaging the seat 18 of the receptacle 14. The tube connector 20 engages the flare end 16 with the externally threaded tubular portion 22 of the connector 20 being fully threaded into the internally threaded tubular portion 24 of the receptacle 14. The flare end 16 includes an outer wall 30 and an inner wall 32. The tube connector 20 engages the outer wall 30 of the flare end 16 and causes the inner wall 32 to form a seal, when properly installed, against the seat 18.

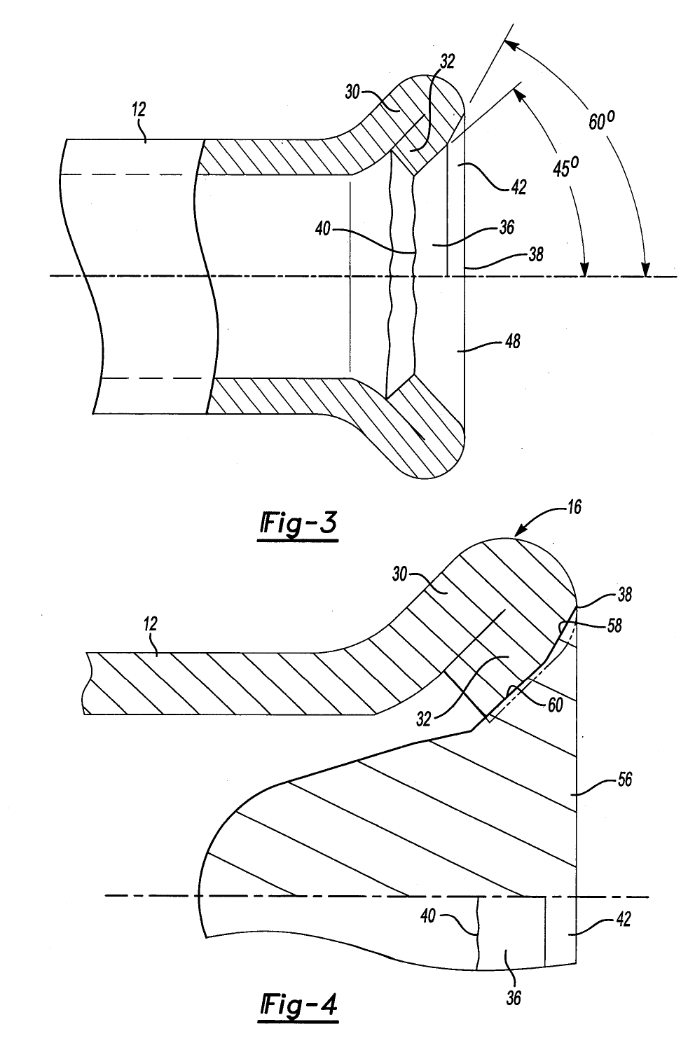

Referring to FIGS. 2 and 3, the flare end 16 according to one embodiment of the invention is shown to include a sealing area 36 that engages the seat 18 in a sealing relationship. A large frustum diameter 38 of the flare end 16 may also be referred to as the plane end of the brake tube 12. It should be understood that the large frustum diameter 38 may be slightly recessed from the flare end 16 and that a radiused area may be provided between the diameter 38 and the flare end 16. A small frustum diameter 40 is formed at the inner end of the inner wall 32.

Referring specifically to FIG. 3, the upper portion of the drawing illustrates one embodiment of the invention wherein a sealing area 36 and chamfered surface 42 are defined as inner surfaces of the inner wall 32. The lower portion of FIG. 3 illustrates one problem with the prior art flare end tubing standards wherein the small frustum diameter 40 is subject to variation represented by the exaggerated non-linear nature of the small frustum diameter 40.

The flare's cone shape is formed by a cone shaped tool that is positioned in a die. During the forming stroke, material of the brake tube flows to fill the cavity between the insert and the die. Variations in the position of the tube relative to the tool, batch-to-batch variations due to different tooling settings, variation in tubing material properties, and tool wear may result in undesired variation in the flare end geometry.

The metal flowing into the cavity between the insert and the die may not entirely fill the available volume. During the forming process, material flows from the large frustum diameter area 38 toward the small frustum diameter 40 along the sealing surface 36. If the material flows to a maximum extent and the available volume between the insert and the die is filled, then an edge may be formed between the sealing area 36 and the large frustum diameter 38. Such an edge may result in misalignment or gouging the surface of the seat 18.

In other instances, the surface adjacent the large frustum diameter may be somewhat rounded which can result from a reduction in the material flow. If the material flow is not sufficient to reach the small frustum diameter 40, the diameter of the small frustum may increase and the small frustum diameter 40 may be somewhat wavy or non-linear. To assure proper length of sealing area 36, the amount of material flowing to form the inner wall 32 must be closely controlled. Reduction and variation at either the small or large frustum diameters 38, 40 tends to be such that reduction and variation at one end of the flare results increased variation at the other end.

Referring to FIG. 4, a forming tool for forming a flare end 16 on a brake tube 12 is illustrated. The flare end 16 made according to this embodiment may be referred to as a bi-cone or two-cone flare end. The flare end 16 is formed by the outer wall 30 and the inner wall 32. The distal end of the flare 16 is the large frustum diameter 38 and may also be referred to as the end plane of the flare end 16. The forming tool 56 includes a large cone forming surface 58 and a sealing area forming cone 60. The large cone forming surface 58 forms the inner wall 32 of the flare end 16 between the sealing area 36 and the large frustum diameter 38. The sealing area forming cone 60 forms the inner wall 32 of the flare end 16 at the sealing area 36. As shown in the lower portion of FIG. 4, the small frustum diameter 40 bounds the sealing area 36, with the chamfered surface 42 bounding the sealing area 36 on the opposite end of the inner wall 32.

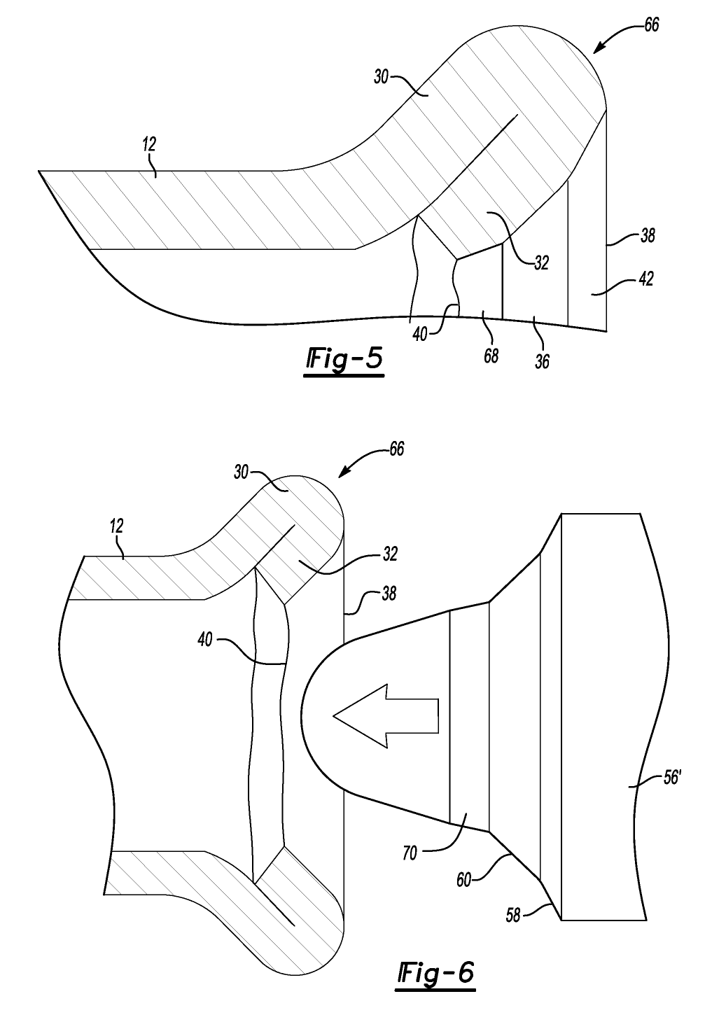

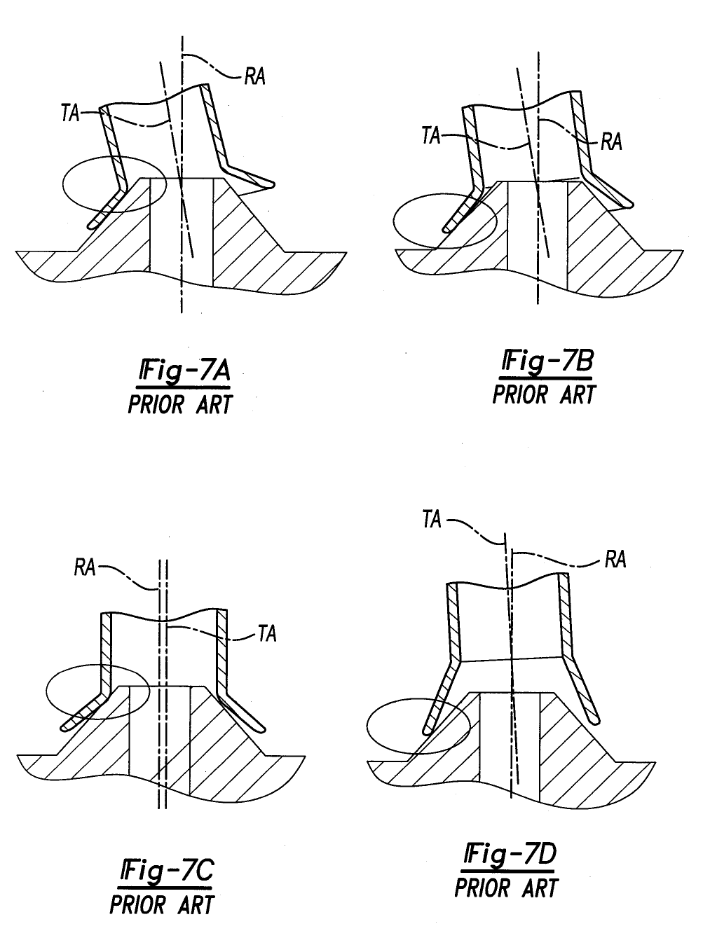

A tri-cone embodiment 66 is illustrated in FIGS. 5 and 6. In FIG. 5, the tri-cone embodiment of the flare end is shown as part of a brake tube 12. To avoid repetition, the same reference numerals will be used with this embodiment as were used for the embodiments of FIGS. 1-4. The brake tube 12 includes an outer wall 30 and an inner wall 32. The inner wall 32 defines the sealing area 36 which is the portion of the flare end 66 that is intended to seal against the seat as previously described. A chamfered surface 42 is provided between the sealing area 36 and the large frustum diameter 38. A run-out cone 68 is formed between the sealing area 36 and the small frustum diameter 40. The edge defined between the sealing area 36 and the run-out cone 68 provides a line of demarcation that is linear and not variable like the small frustum diameter 40. This linear edge facilitates measurement of the length of the sealing area 36.

An alternative bi-cone embodiment may be provided with reference to FIGS. 5 and 6, in which the chamfered surface 42 is eliminated from the tri-cone embodiment 66. The inner wall 32 in this embodiment defines the sealing area 36 and the run-out cone 68. At the flare end 16 the inner wall 32 would be formed as in the prior art and may include a radius as a result of the flare end forming process.

Referring specifically to FIG. 6, a brake tube 12 is shown that includes an outer wall 30 and an inner wall 32. A forming tool 56′ is shown prior to engaging the end flare 66. The forming tool 56′ includes a large cone forming surface 58 that engages the inner wall 32 to form the chamfered surface 42. Sealing area forming cone 60 is used to form the sealing area 36. A small cone forming surface 70 is used to form the run-out cone 68.

With reference to FIG. 4, it will be readily appreciated that the length of the sealing area 36 can be better controlled in the tri-cone embodiment 66 since the material of the inner wall 32 is formed to define edges at the intersection of the large cone forming surface 58, sealing area forming cone 60, and small cone forming surface 70.

While the best mode for carrying out the invention has been described in detail, those familiar with the art to which this invention relates will recognize various alternative designs and embodiments for practicing the invention as defined by the following claims.

What is claimed:

1. A brake line for a brake system of a vehicle comprising:
a tube having first and second ends;
the first and second ends each have an outer wall that is flared outwardly in the shape of a frustum of a cone, the ends each have a reversely turned portion that defines an inner wall that is formed with a sealing area in the shape of a frustum of a cone, the inner wall being nested within the outer wall, the inner wall being relieved at a large frustum diameter of the inner wall relative to the sealing area, and the inner wall being relieved at a small frustum diameter of the inner wall relative to the sealing area; and
wherein the length of the sealing area as measured from the large frustum diameter to the small frustum diameter is specified as a critical dimension that is not permitted to be less than a predetermined value.

2. The brake line of claim 1 wherein the large frustum diameter is relieved by a partially conical, run-out surface that extends at an oblique angle relative to the sealing area.

3. The brake line of claim 2 wherein the sealing area is disposed at about a 45 degree angle relative to a central axis of the tube and the run-out surface extends at an angle of between 55° and 85° relative to the central axis of the tube.

4. The brake line of claim 1 wherein the small frustum diameter is relieved by a partially conical, run-out surface that extends at an oblique angle relative to the sealing area.

5. The brake line of claim 4 wherein the sealing area is disposed at about a 45 degree angle relative to a central axis of the tube and the run-out surface extends at an angle of between 5° to 40° relative to the central axis of the tube.

6. The brake line of claim 1 wherein the critical dimension is greater than 0.75 mm.

7. A hydraulic tubing connector assembly comprising:
a receptacle having a tubular projection that defines a sealing seat, the sealing seat being tapered from a large frustum diameter to a small frustum diameter with the small frustum diameter projecting to a greater extent than the large frustum diameter, the receptacle having a threaded bore spaced radially outwardly from the tubular projection;
a tube secured to the receptacle, the tube having an end that has an outer wall that is flared outwardly to form a frustum of a cone, the end having a reversely turned portion that defines an inner wall that is formed with a sealing area in the shape of a frustum of a cone that is oriented generally at the same angular orientation as the outer wall, the inner wall having a chamfered surface at the large frustum diameter of the inner wall that has an increased angle of inclination relative to a central axis of the tube than the angle of inclination of the sealing area relative to the central axis of the tube; and
a tubular fastener having a threaded surface that is screwed into the threaded bore of the receptacle, an engagement surface in the shape of a frustum of a cone on a distal end of the fastener that bears upon on the outer wall of the tube, wherein the inner wall of the tube seals against the sealing seat of the receptacle.

8. The hydraulic tubing connector of claim 7 wherein a small frustum diameter of the inner wall is defined by a run-out surface that is formed as a frustum of a cone that has a lesser angle of inclination than the sealing area.

9. The hydraulic tubing connector of claim 7 wherein the sealing area of the inner wall is oriented at an angle of inclination relative to a central axis of the tube that is equal to A and the chamfered surface at the large frustum diameter of the inner wall has an angle of inclination relative to the central axis of the tube that is equal to B, wherein A is less than B.

10. The hydraulic tubing connector of claim 9 wherein a small frustum diameter of the inner wall is defined by a run-out surface that is formed as a frustum of a cone that has an angle of inclination relative to the central axis of the tube that is equal to C, wherein C is less than A.

11. The hydraulic tubing connector of claim 10 wherein the sealing area is defined by a first edge on the large frustum diameter by the intersection of the chamfered surface and the sealing area and by a second edge on the small frustum diameter by the intersection of the run-out surface and the sealing area.

12. A brake line for a brake system of a vehicle comprising:
a tube having first and second ends;
the first and second ends each have an outer wall that is flared outwardly in the shape of a frustum of a cone, the ends each have a reversely turned portion that defines an inner wall that is formed with a sealing area in the shape of a frustum of a cone, the inner wall being nested within the outer wall, the inner wall having a run-out surface that is formed as a frustum of a cone at a small frustum diameter of the inner wall that has a lesser angle of inclination relative to an axis of the tube in comparison to the angle of inclination of the sealing area relative to the axis of the tube.

13. The brake line of claim 12 wherein the sealing area of the inner wall is oriented at an angle of inclination relative to a central axis of the tube that is equal to A and a chamfered surface is provided that has an angle of inclination relative to the central axis of the tube that is equal to B, wherein A is less than B.

14. The brake line of claim 12 wherein a chamfered surface at the large frustum diameter of the inner wall has a greater angle of inclination than is defined by the sealing area.

15. The brake line of claim 14 wherein a small frustum diameter of the inner wall is defined by a surface that is formed as a frustum of a cone that has an angle of inclination relative to the central axis of the tube that is equal to C, wherein C is less than A.

16. The brake line of claim 15 wherein the sealing area is defined by a first edge on the large frustum diameter by the intersection of the chamfered surface and the sealing area and by a second edge on the small frustum diameter by the intersection of the run-out surface and the sealing area.
